(19) United States
(12) Patent Application Publication
(10) Pub. No.: US 2010/0158209 A1
(43) Pub. Date: Jun. 24, 2010

(54) Access to Network Based on Automatic Speech-Recognition

(75) Inventor: Glenn D. Altchek, Lawrenceville, NJ (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 12/341,436

(22) Filed: Dec. 22, 2008

(51) Int. Cl. H04L 12/66; H04M 1/64

(52) U.S. Cl. 379/88.03; 370/353

(57) ABSTRACT

A device for accessing a network based on automatic speech-recognition includes an audio port configured to communicate audio signals with a customer premise equipment (CPE) device and a data packet port configured to communicate data packets with the network. The device also includes a processor configured to convert the audio signals into the data packets and vice versa, detect in the audio signals from the CPE device a verbal command to dial a telephone number, and enable a dialing of the telephone number through the network.

### BACKGROUND

Voice over Internet Protocol (VoIP) allows telephone calls to be made from any location around the world via a VoIP network such as the Internet. A VoIP device such as an analog terminal adaptor (ATA), a multimedia terminal adaptor (MTA), an embedded MTA (EMTA), etc., enables users to make and receive telephone calls from a customer premise equipment (CPE) device via a VoIP network such as the Internet by connecting a portable VoIP device to the VoIP network, where the VoIP device operates as an interface between a telephone and the VoIP network.

In operating as an interface between a telephone and a VoIP network, an automatic speech-recognition in VoIP devices may be useful in dialing telephone numbers.

### BRIEF DESCRIPTION OF THE DRAWINGS

The embodiments of the invention will be described in detail in the following description with reference to the following figures.

FIG. 1 illustrates a system with a VoIP device configured to recognize in audio signals from a CPE device a verbal command to dial a telephone number, according to an embodiment of the invention;

FIG. 2 illustrates a VoIP device including a control processor for controlling the operations of the VoIP device, according to an embodiment of the invention; and

FIG. 3 illustrates a flow-chart of a method for accessing a network based on automatic speech-recognition, according to an embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. In other instances, well known methods and structures have not been described in detail so as not to unnecessarily obscure the embodiments.

As referred to in this disclosure, a VoIP device may be any reasonably suitable adaptor such as an ATA, MTA, etc., that converts audio signals received from an audio port to data packets by at least adding header fields for outputting the converted data packets to a data packet port and converts data packets received from the data packet port to audio signals by at least stripping header fields from the data packets for outputting the converted audio signals to the audio port. An MTA may be combined with a modem to form an EMTA, and the EMTA in turn may be combined with a cordless base station, where the base station is used to send data received by the EMTA to a CPE device such as a telephone, a computer, a voice answering machine, etc., over one or more wireless communication channels.

As referred to in this disclosure, data packets each include a header field and a data field, where the header fields are used for processing data packets and may each include at least one of a source Internet Protocol (IP) address, a destination IP address, a time, and any other data related to processing of data packets including cyclic redundancy check (CRC) bits.

According an embodiment, a VoIP device for enabling an access to a network based on automatic speech-recognition includes a digital signal processor (DSP) for converting audio signals received from a CPE device into data packets by adding packet headers used in routing the data packets through a packet-switched network. The DSP is configured to detect in audio signals from the CPE device a verbal command to dial a telephone number and enable a dialing of the telephone number through the network.

A directory of a list of names and corresponding telephone numbers may be stored in a data storage device within the VoIP device or within a computer coupled to the VoIP device through a local area network (LAN). The directory stored in the data storage device may be used by the DSP, and the DSP may retrieve a telephone number of a corresponding name in the directory that matches a name included in the verbal command. Alternatively, the verbal command may include a telephone number, and the DSP may enable a dialing of the telephone number without referencing any directory of telephone numbers. As referred to in this disclosure, enabling of a dialing of a telephone number includes any reasonably suitable enablement of dialing a telephone number by a VoIP device including triggering a dialing of the telephone number, establishing a call connection with a telephone of the call recipient through a network, etc.

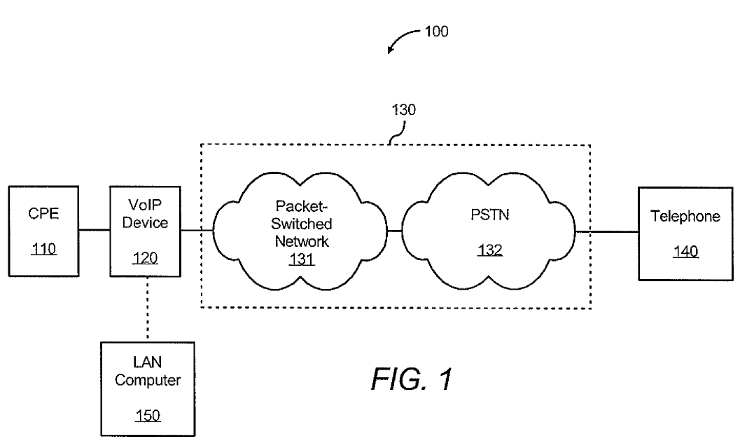

FIG. 1 illustrates a system 100 with a VoIP device 120 configured to recognize in audio signals from a CPE device 110 a verbal command to dial a telephone number, according to an embodiment. It should be understood that the system 100 may include additional components and that some of the components described herein may be removed and/or modified without departing from a scope of the system 100. While one CPE device 110 is shown, multiple CPE devices 110 may communicate with the VoIP device 120 and may each transmit audio signals. Further, while the system 100 and its components and features are explained in this disclosure in relation to a verbal command to dial a telephone number, other verbal commands may be included in audio signals from the CPE device 110 to control operations of the system 100 such as display settings, volumes, etc., in the VoIP device 120. The description and features of the system 100 applicable to a verbal command to dial a telephone number are also applicable to other verbal commands in audio signals from the CPE device 110 unless clearly contradictory.

The system 100 includes the CPE device 110, the VoIP device 120, a network 130, a telephone 140, and a LAN computer 150.

In describing the components of the system 100 more specifically, the CPE device 110 may be any reasonably suitable device for communicating analog or digital audio signals such as a telephone, a computer, etc. In communicating audio signals representing a verbal command to dial a telephone number, when a user speaks a verbal command into a microphone of the CPE device 110, the CPE device 110 generates analog or digital audio signals representing the verbal command, where the verbal command may be reproduced in audio from the audio signals. The verbal command may be any reasonably suitable verbal command recognized by the VoIP device 120 as a command to dial a telephone number. For example, the verbal command may be a string of speech starting with a phrase such as “please call” and ending with a name. A verbal command to dial a telephone number may be selectively chosen to reduce a possible confusion with other audio sounds and other verbal commands such as a command to control display or other device settings on the VoIP device 120. While only one CPE device 110 is shown, a plurality of CPE devices 110 may also be connected to and communicate through the VoIP device 120, where a user of each CPE device 110 may be required to sign in with the VoIP device 120, so that a corresponding directory of a list of names and corresponding telephone numbers for the user in a data storage device may be looked up in locating a telephone number to call in response to a verbal command to automatically dial a telephone number.

The VoIP device 120 receives audio signals from the CPE device 110 and converts the audio signals received from the CPE device 110 into data packets by at least adding packet headers and transmits the data packets to the network 130. The components of the VoIP device 120 may be in a single housing or in multiple housings. In receiving data packets from the network 130 that correspond to audio signals from a telephone call with the CPE device 110, the VoIP device 120 converts the received data packets into audio signals by at least stripping packet headers of the data packets and communicates the audio signals to the CPE device 110.

In dialing a telephone number by automatic speech-recognition in the VoIP device 120, the VoIP device 120 detects a verbal command to dial a telephone number in audio signals from the CPE device 110. If the verbal command is detected or determined by the VoIP device 120 to be a command to dial a telephone number of a person, whose name is included in the verbal command, the VoIP device 120 finds a matching name in a directory of a list of names and corresponding telephone numbers and selects the telephone number corresponding to the matching name as a telephone number to dial. Once the telephone number to be dialed is selected from the directory, the VoIP device 120 enables a dialing of the telephone number, where the call is connected through the network 130. Alternative to and/or in conjunction with the above-described use of a telephone directory, if a verbal command to call a telephone number is determined to include the telephone number itself, the VoIP device 120 may enable the dialing of the telephone number directly without referencing any directory of telephone numbers. After the telephone call is established, the VoIP device 120 communicates data packets corresponding to audio signals produced by the CPE device 110 and receives through the network 130 data packets corresponding to audio signals produced by the telephone 140.

If there are multiple users using the VoIP device 120, in finding a telephone number from a directory of a list of names and corresponding telephone numbers, the VoIP device 120 may first select one of a plurality of directories that corresponds to a directory of a current user. For example, as described-above, different users may use the VoIP device 120 through different CPE devices 110. After a user of a CPE device 110 currently using the VoIP device 120 is recognized, for example, through a log-in session to verify a user or a particular CPE device 110, the VoIP device 120 may select a directory among multiple directories that corresponds to the directory of the current user or the particular CPE device 110. Once the corresponding directory of the current user is found, a telephone number in the directory corresponding to a name in the directory that matches a name in the detected verbal command is selected as a telephone number to be dialed. As described above, alternative to and/or in conjunction with use of a telephone directory, if the verbal command is determined to include a telephone number itself, the VoIP device 120 may dial the telephone number directly without referencing any directory of telephone numbers.

The LAN computer 150 may be coupled to the VoIP device 120 to enable resources of the LAN computer 150 and the VoIP device 120 such as data storage devices and CPUs to be shared. For example, the LAN computer 150 may include a data storage device for storing directories of a list of names and corresponding telephone numbers, where the VoIP device 120 uses the directories for dialing a telephone number as described above.

The network 130 includes a packet-switched network 131 and a public switched telephone network (PSTN) 132, and allows transmission of data packets to and from the VoIP device 120 through the packet-switched network 131 and another network, such as the PSTN 132, of the network 130. While the network 130 in FIG. 1 is shown as having the packet-switched network 131 and the PSTN 132 according to an embodiment of the invention, it should be understood that the network 130 may include additional components and that some of the components described herein may be removed and/or modified without departing from a scope of the network 130. For example, if the telephone number does not correspond to a telephone connected to the PSTN but corresponds to another VoIP device and a CPE device connected to the VoIP device, the telephone call may be connected through the packet-switched network 131 to a node assigned to the telephone number without being communicated through the PSTN 132.

In discussing components of the network 130 in more detail, the packet-switched network 131 may be any reasonably suitable network for transmitting and managing data packets in the network based on a header field of each data packet such as the Internet. The PSTN 132 is a network of the world's public circuit-switched telephone networks and converts data packets received from the packet-switched network 131 into audio signals before being forwarded to a telephone line of a recipient of a telephone call.

In describing operations of routing data packets through the network 130 in connection with data packets communicated through the VoIP device 120, the data packets may be transferred to and from another VoIP device connected to the packet-switched network 131 directly. Alternatively, in cases of telephone calls, data packets corresponding to a telephone call, may be transferred to and from a telephone user by communicating the data packets through both the packet-switched network 131 and another network such as the PSTN 132 before reaching the other user.

The telephone 140 may be any reasonably suitable device for converting audio sounds detected by, for example, a microphone of the telephone 140 into audio signals and converting audio signals received from the PSTN 132 into audio sounds. While the telephone 140 is shown, alternatively, the call recipient at the telephone number dialed by the CPE device 110 may be a user of another CPE device 110 connected to the packet-switched network 130 directly through another VoIP device 120. The operations of the second VoIP device 120 and the second CPE device 110 is the same as those of the operations of the VoIP device 120 and the CPE device 110.

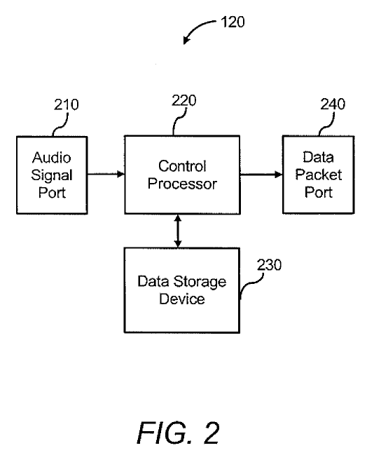

Now turning to FIG. 2, shown therein is the VoIP device 120 including a control processor 220 for controlling the operations of the VoIP device 120 according to an embodiment of the invention. It should be understood that the VoIP device 120 may include additional components and that some of the components described herein may be removed and/or modified without departing from a scope of the VoIP device 120. For instance, the VoIP device 120 may include one or more of a modem, an MTA, a cordless base station and a wireless router.

In describing the VoIP device 120 more specifically, the VoIP device 120 may include an audio port 210 and a data packet port 240. The audio port 210 may be any reasonably suitable audio port for receiving and transmitting audio signals and may include one port or separate ports for performing the receipt and transmission of audio signals, respectively. The data packet port 240 may be any reasonably suitable port for receiving and transmitting data packets and may include one port or separate ports for performing the receipt and the transmission of audio signals, respectively.

A control processor 220 may be any reasonably suitable processor such as a DSP to convert the audio signals into data packets and vice versa and enable the VoIP device 120 to communicate the audio signals through the audio port 210 and the data packets through the data packet port 240. The control processor 220 may be a single processor for performing both the signal conversion operations and the automatic speech-recognition operations described above. Alternatively, the control processor 220 may include a separate processor such as a DSP for performing the signal conversion operations and a separate processor such as a general central processing unit (CPU) for performing the automatic speech-recognition operations described above. The automatic speech-recognition in the VoIP device 120 may be performed by the control processor 220 by analyzing audio signals received at the audio signal port 210 and determining that the audio signals include a representation of a verbal command, where the audio signals are capable of reproducing the verbal command in audio.

A data storage device 230 includes instructions used by the control processor 220 in performing the operations of the VoIP device 120. The data storage device 230 may also include a directory of a list of names and corresponding telephone numbers for being used by the control processor 220 in selecting a telephone number to be dialed from the directory. Alternatively, the directory of a list of names and corresponding telephone numbers may instead be stored at a data storage device within the LAN computer 150.

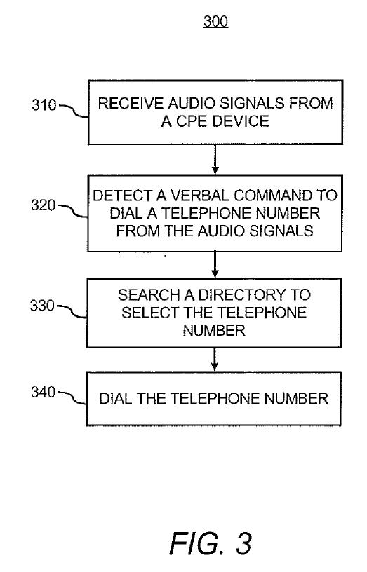

Turning now to FIG. 3, shown therein is a method 300 for accessing a network based on automatic speech-recognition according to an embodiment of the invention. It should be apparent to those of ordinary skill in the art that other steps may be added or existing steps may be removed, modified or rearranged without departing from a scope of the method 300.

At step 310, the VoIP device 120 receives audio signals from the CPE device 110.

At step 320, the VoIP device 120 detects a verbal command to dial a telephone number from the received audio signals.

At step 330, the VoIP device 120 searches a directory of a list of names and corresponding telephone numbers to select a telephone number corresponding to a name in the directory that matches a name included in the verbal command.

At step 340, the VoIP device 120 dials the selected telephone number.

With the automatic speech recognition in the VoIP device 120, valuable network communication-channel bandwidth allocable for handling network data-traffic dedicated to having the automatic speech recognition elsewhere may be conserved for other purposes. Further, since the control processor 220 of the VoIP device 120 is typically not handling heavy network traffic when the automatic speech recognition in the VoIP device 120 is being used, excess processor capacity of the control processor 220 may be allocated for performing operations for the automatic speech recognition.

Any one or more of the above-described operations of the system 100 and the VoIP device 120 in reference to exemplary features and embodiments of FIGS. 1-3 may be contained as a computer program product embodied on one or more tangible computer readable storage mediums. The computer program product may exist in a variety of forms both active and inactive. For instance, the computer program product may exist as software program(s) including program instructions in source code, object code, executable code or other formats whether compressed or uncompressed. Exemplary tangible computer readable storage mediums include conventional computer system RAM, ROM, EPROM, EEPROM, and magnetic or optical disks or tapes.

While exemplary features and embodiments of FIGS. 1-3 have been explained within the context of each feature and embodiment, any one or more of the exemplary features and embodiments of the invention may be applied and is incorporated in any and all of the embodiments of the invention unless clearly contradictory.

While the embodiments have been described with reference to examples, those skilled in the art will be able to make various modifications to the described embodiments without departing from the scope of the claimed embodiments.

What is claimed is:

1. A device for accessing a network based on automatic speech-recognition, the device comprising:
an audio port configured to communicate audio signals with a customer premise equipment (CPE) device;
a data packet port configured to communicate data packets with the network;
at least one processor configured to convert the audio signals into the data packets by at least adding header fields and vice versa by stripping header fields, detect in the audio signals from the CPE device a verbal command to dial a telephone number, and enable a dialing of the telephone number through the network in response to the detection.

2. The device of claim 1, wherein the at least one processor is further configured to access a directory of a list of names and corresponding telephone numbers stored at a data storage device and select one of the telephone numbers corresponding to a name in the directory that matches a name in the verbal command as the telephone number to be dialed.

3. The device of claim 2, wherein the data storage device is a computer connected to the device through a local area network (LAN).

4. The device of claim 1, wherein the at least one processor is configured to select, from a plurality of directories of a list of names and corresponding telephone numbers stored at a data storage device, one of the plurality of directories that corresponds to a current user of the CPE device and select one of the telephone numbers in the selected directory as the telephone number to be dialed.

5. The device of claim 1, wherein, when the verbal command includes a telephone number, the at least one processor is configured to enable a dialing of the telephone number included in the verbal command.

6. The device of claim 1, wherein the at least one processor includes a digital signal processor configured to convert the audio signals into the data packets by at least adding header fields and a central processing unit to detect the verbal command to dial a telephone number in the audio signals from the CPE device.

7. The device of claim 1, further comprising a data storage device for storing instructions to be performed by the at least one processor in detecting the verbal command to dial a telephone number.

8. The device of claim 1, wherein the device is a multimedia terminal adaptor (MTA).

9. A method of accessing a network based on automatic speech-recognition, the method comprising:
in a device connected to a network,
receiving audio signals from a customer premise equipment (CPE) device;
converting the audio signals into data packets by at least adding header fields;
detecting in the audio signals from the CPE device a verbal command to dial a telephone number; and
enabling a dialing of the telephone number through the network in response to the detection of the verbal command.

10. The method of claim 9, further comprising:
accessing a directory of a list of names and corresponding telephone numbers stored at a data storage device; and
selecting one of the telephone numbers corresponding to a name in the directory that matches a name in the verbal command as the telephone number to be dialed.

11. The method of claim 10, wherein the data storage device is a computer connected to the device through a local area network (LAN).

12. The method of claim 9, further comprising:
selecting, from a plurality of directories of a list of names and corresponding telephone numbers stored at a data storage device, one of the plurality of directories that corresponds to a current user of the CPE device; and
selecting one of the telephone numbers in the selected directory as the telephone number to be dialed.

13. The method of claim 9, wherein, when the verbal command includes a telephone number, enabling a dialing of the telephone number includes a dialing of the telephone number included in the verbal command.

14. The method of claim 9, further comprising:
using a digital signal processor to convert the audio signals into the data packets by at least adding header fields; and
using a central processing unit to detect the verbal command to dial a telephone number in the audio signals from the CPE device.

15. The method of claim 9, wherein the device is a multimedia terminal adaptor (MTA).

16. The method of claim 9, wherein the detection of the verbal command at the device avoids exchanging data between the device and the network for performing the detection at the network and conserves network resources for other purposes.

17. The method of claim 9, further comprising using a control processor of the device for performing the detection when the control processor is not transmitting network traffic.

18. A computer program product embodied on one or more computer readable storage mediums for enabling a network access based on automatic speech-recognition, the computer program product comprising instructions for:
in a device connected to a network,
receiving audio signals from a customer premise equipment (CPE) device;
converting the audio signals into data packets by at least adding header fields;
detecting in the audio signals from the CPE device a verbal command to dial a telephone number; and
enabling a dialing of the telephone number through the network in response to the detection of the verbal command.

19. The computer program product of claim 18, further comprising instructions for:
accessing a directory of a list of names and corresponding telephone numbers stored at a data storage device; and
selecting one of the telephone numbers corresponding to a name in the directory that matches a name in the verbal command as the telephone number to be dialed.

20. The computer program product of claim 19, wherein the data storage device is a computer connected to the device through a local area network (LAN).
